(19) United States
(12) Patent Application Publication
(10) Pub. No.: US 2002/0113075 A1
(43) Pub. Date: Aug. 22, 2002

(54) Machine for vending articles and methods associated therewith

(76) Inventor: Munroe Chirnomas, Morris Township, NJ (US)

Correspondence Address: AUTOMATIC IMPULSE MACHINE DESIGN INC, LAWRENCE C EDELMAN, IP COUNSEL, 1 CORY RD, MORRIS TOWNSHIP, NJ, 07960, US

(21) Appl. No.: 09/998,374

(22) Filed: Nov. 29, 2001

Related U.S. Application Data
(63) Continuation-in-part of application No. PCT/US01/16853, filed on May 23, 2001.
(63) Continuation-in-part of application No. PCT/US01/16893, filed on May 23, 2001.
(63) Continuation-in-part of application No. PCT/US01/16837, filed on May 23, 2001.
(63) Continuation-in-part of application No. PCT/US01/16847, filed on May 23, 2001.
(63) Continuation-in-part of application No. PCT/US01/16846, filed on May 23, 2001.
(63) Continuation-in-part of application No. PCT/US01/16894, filed on May 23, 2001.
(63) Continuation-in-part of application No. 09/633,477, filed on Aug. 7, 2000.
(60) Provisional application No. 60/257,316, filed on Dec. 21, 2000.
(60) Provisional application No. 60/206,363, filed on May 23, 2000.
(60) Provisional application No. 60/147,832, filed on Aug. 7, 1999.
(60) Provisional application No. 60/261,964, filed on Jan. 16, 2001.
(60) Provisional application No. 60/294,284, filed on May 29, 2001.
(60) Provisional application No. 60/296,675, filed on Jun. 7, 2001.

(51) Int. Cl. G07F 11/00

(52) U.S. Cl. 221/9

(57) ABSTRACT

A method and apparatus are disclosed relating to the renting, leasing and/or loaning, etc. of electronic equipment operable and/or controllable by a computer, wherein one entity not in physical possession and/or control of the equipment wishes to have some control over another entity that has physical possession and/or control of the equipment. Such equipment may comprise a washing machine, medical, office or industrial equipment, vending machines, etc. A central computer system includes software which enables management and execution of financial transactions between the entities. Such transactions may include debiting or crediting accounts of various other entities or creating a bill or invoice for one entity to present to another entity. Information used in making this financial transaction is determined from analysis of information which may be communicated to the central computer system from at least one other source. Other sources may include, the control system of the controlled equipment, such as from a vending machine or, for example, the computer network or system of an involved or interested entity.

### CROSS-REFERENCE TO RELATED APPLICATIONS

This application claims priority of and is a continuation in part of: (i) PCT/US01/16853, filed May 23, 2001, entitled METHOD AND APPARATUS FOR INCLUDING ARTICLE IDENTIFICATION IN AN ARTICLE HANDLING DEVICE; (ii) PCT/US01/16893, filed May 23, 2001, entitled METHODS OF DOING THE BUSINESS OF MACHINE VENDING (which claims the benefit of U.S. Provisional Patent Application No. 60/257,316, filed Dec. 21, 2000, entitled METHOD AND APPARATUS FOR ARTICLE HANDLING, SUCH AS FOR A VENDING MACHINE); (iii) PCT/US01/16837, filed May 23, 2001, entitled METHOD AND APPARATUS FOR CONTROLLING A VENDING MACHINE; (iv) PCT/US01/16847, filed May 23, 2001, entitled METHOD AND APPARATUS FOR STORING ARTICLES FOR USE WITH AN ARTICLE HANDLING DEVICE; (v) PCT/US01/16846, filed May 23, 2001, entitled METHOD AND APPARATUS FOR HOSE STORAGE IN AN ARTICLE HANDLING DEVICE; (vi) PCT/US01/16894, filed May 23, 2001, entitled METHOD AND APPARATUS FOR POSITIONING AN ARTICLE HANDLING DEVICE, all of the above patent applications claim the benefit of U.S. Provisional Patent Application No. 60/206,363, filed May 23, 2000, entitled METHOD AND APPARATUS FOR ARTICLE HANDLING, SUCH AS FOR A VENDING MACHINE.

This application also claims priority of and is a continuation in part of: (vii)International Publication No. WO 01/11578, filed Aug. 7, 2000, entitled VENDING MACHINE (which claims the benefit of U.S. Provisional Patent Application No. 60/147,832, filed Aug. 7, 1999, entitled VENDING MACHINE), and (viii) its corresponding US application U.S. Ser. No. 09/633,477. (ix) U.S. Provisional Patent Application No. 60/257,316, filed Dec. 21, 2000 and entitled METHOD AND APPARATUS FOR ARTICLE HANDLING, SUCH AS FOR A VENDING MACHINE; and (x) U.S. Provisional Patent Application No. 60/261,964, filed Jan. 16, 2001 and entitled METHOD AND APPARATUS FOR ARTICLE HANDLING AND DISPENSING DEVICES; (xi) U.S. Provisional Patent Application No. 60/294,284, filed May 29, 2001, entitled METHOD AND APPARATUS FOR QUICK CHANGE DISPLAY GRAPHICS ON A MERCHANDISER; and (xii) U.S. Provisional Patent Application No. 60/296,675, filed Jun. 7, 2001, entitled METHOD AND APPARATUS FOR ARTICLE HANDLING, SUCH AS WITH A VENDING MACHINE.

This application also claims priority of and is a continuation in part of: (xiii) U.S. Provisional Patent Application No (attorney docket #01PR19US) filed Nov. 23, 2001 in the name of Munroe Chirnomas and entitled MACHINE FOR VENDING ARTICLES AND METHODS ASSOCIATED THEREWITH, and of (xiv) U.S. Provisional Patent Application No (attorney docket #01PA20US) filed Nov. 23, 2001 in the name of Munroe Chirnomas and entitled METHOD AND APPARATUS FOR VENDING GOODS. The entire disclosures of all of the above patent applications are incorporated herein by reference, at least for US purposes.

### DETAILED DESCRIPTION

The following descriptive material is for use in combination with the descriptions in the attached EXHIBITs, in order to further describe and/or clarify various features and aspects of the invention.

In the attached description (corresponding substantially to the forenoted U.S. patent application Ser. No. 09/991,767 (attorney docket #01PA20US), in accordance with several aspects of the invention, consider the following:

The invention disclosed therein has applicability to the renting, leasing and/or loaning, etc. of other electronic equipment, such as a washing machine, office equipment, industrial or medical equipment, and many other types of equipment operable and/or controllable by a computer, wherein the one entity wishes to have some control over another entity that has physical possession and/or control of the equipment.

Accordingly, in the attached description (corresponding substantially to the forenoted U.S. patent application Ser. No. 09/991,767 (attorney docket #01PA20US), consider that various features and aspects of the invention described therein are applicable to such equipment.

In one embodiment of a multiple robot configuration may be contained within a warehousing structure. The system can utilize a common computer system to control all processes including conveyance, dispensing and monitoring whereby at least one conveyor system for moving a containment structure, such as a bag, basket, box or other type of container from one location to another, the system further having at least two robots are positioned so as to be operative to remove articles from storage bins (eg. Typically articles of different types with different storage requirements) within the reach of the respective robots. The conveyor system which may be of many varied methods generally known can convey the container in order to allow the robots to place articles within their reach into the common bag or box prior to dispensing or conveying the container or box to a customer retrieval location. This customer retrieval location or locations can be remote to the housing structure that contains the article storage facilities and or the article conveyor systems. Additionally the other described aspects of the invention, such as article ID systems, control techniques and mechanical apparatus described herein may be applied to this embodiment. Other aspects that can be utilized advantageously here may be connection to a computer network such as the internet, LAN, WAN, Wireless etc. wherein a customer or user may monitor or order from the system. In one scenario, the user can order articles to be dispensed over the computer network and have them ready and waiting in a customer holding area so that the customer can retrieve the container or articles at a later time. A user can also use a touch screen in proximity to the automated dispensing system or retrieval area and or the remote computer system or network to check the inventory or availability of a specific item or items. In a further embodiment, this system can also be utilized as a mini warehouse system. In this scenario, the storage areas may contain articles or packages which are placed there specifically for access and retrieval by a certain person or entity. Using a passcode or access card or similar device or using a payment method, the user can retrieve packages such as parcels, letters, or other shipped goods from the storage area. This provides for a very convenient system since traditional deliveries to a person or entities home or place of business often requiring a physical signature and for a both parties to be present to receive and have the article delivered. Instead, the delivering party and the receiving party can use the article storage and dispensing apparatus as an exchange device allowing for the two parties to carry out the transfer of goods without having the requirement of being at the same place at the same time. Additionally, the use of a pass code or a swipe card, which may be connected to a gasoline pump, or any one of a multitude of devices, including biometric devices such as facial or fingerprint recognition, could be used as a verifiable electronic signature to ensure accountability. The elements described herein can be used in various other useful combinations which are considered part of the invention.

This dispensing apparatus can be used in locations such as Gas Station islands, parking lots or convenience stores etc. whereby products are delivered to customers from the dispensing apparatus, for example, using a pneumatic tube, or a conveyor system bringing articles from a remote storage area of the vending apparatus to a location on the perimeter of the apparatus housing, or to location external and or remote to the housing of the apparatus whereby the customer interface, such as a touch screen device and remote retrieval area can be accessed by the customer for remote delivery of articles conveyed and dispensed from the vending apparatus. The described invention can be used in an automated supermarket and such things as automated storerooms or stockrooms in office buildings and commercial locations.

Furthermore, where the central computer system has software code that enables it to manage, determine, and execute the financial matters between the entities. Such matters may include debiting or crediting accounts of various of the involved entities or creating a bill or invoice for one entity to present to another entity. This financial information is determined from analysis of the information which may be communicated to the central computer system from at least one other source. Other sources may include, the control system of the vending apparatus or, for example, the computer network or system of an involved or interested entity.

In one scenario, an operator desires a vending apparatus so he can place it at a specific location. In some instances, an operator doesn't know how much activity the machine will get and he therefore may have to decide whether he can justify placing the machine at the location. One of the significant factors needed to make the decision for whether or not to place the vending machine in a location (or for that matter, whether or not to buy or lease or rent the machine at all) is obviously the cost of the machine. While various traditional financing methods may be useful to stretch out the cost of the machine over time, none are designed to determine the payment or payments to be paid for the machine, by the operator or other interested entity, based on the performance parameters of the machine in a specific circumstance. For example, a parameter may be the amount of money inserted into the machine over a specific time period. Alternatively (or additionally) another parameter may be how many units were sold over a specific time or further without any measured relationship to a time element. So, for example, the seller or owner of the machine may wish to lease or rent or sell the equipment to an operator or user and is willing to have the cost of the equipment to the operator or user be determined at least partially (or fully, if agreed) based on a parameter related to the machine, such as the amount of sales generated from the machine. Following this scenario, a machine manufacturer or a leasing company may be willing to lease or rent the equipment to the operator (operator could be a buyer in this case or a renter etc.) for a payment or price that is less than the traditional market price equivalent. The monthly payment may, for example, have a very nominal (or none at all) profit margin for the machine manufacturer or leasing company to benefit from initially. The regular payment (if there is agreed to be one at all) is fixed in this example and the user or operator must pay additional payments which are determined based on his usage of the equipment. Furthermore, the equipment may have a minimal or limited ability to operate, either in terms of features which are limited or in terms of usage which may be limited or restricted. So, for example, a given piece of equipment may be pre-programmed to disable if more than $3,000 of vending or revenue has occurred within a time frame of one year. The control system may be further programmed to reset a specific counter, which counts the money received by the machine, whenever the time interval of one year has passed. Therefore, if the operator finds himself having vended $2,954 dollars within a twelve month interval, he doesn't have to worry about the machine disabling, since on the first day of the new cycle the meter will turn back to $0 dollars vended and will again allow another $3,000 to be vended over the subsequent twelve months. However, if the operator has vended $3,000 worth of goods and there are still, for example, 3 months left in the year the machine will be disabled. In order to avoid the disabling of the machine, the operator would, for example, contact the management entity who controls the enabling codes for the machine and the operator would pay (or agree to be billed for ) an increased ability to utilize the equipment. The operator may choose to pay for the ability to vend, for example, $1,500 of additional goods during the remaining 3 months of the year. Of course the system can be set to allow any remaining additionally ability to use purchased usage credits, to continue into the following time interval or period of the following year so in this way, an operator doesn't need to be accurate in predicting his additional usage requirements on a given machine. The managing entity, typically a manager which represents the owner or leasing company or manufacturer, will determine (possibly automatically through use of the central computer system)whether or not to release an authorization code such as a continuation code (or an enable, re-enable etc. code as the case may be, a re-enable code is needed after the equipment has already been shut down) to the operator or entity requesting the code. Once the code is received and accepted by the computer control system of the vending apparatus, the vending machine will continue on as per the specific instructions of the latest received authorization code. The authorization code might, for example, also change the ongoing limitations of the machine if so determined. For example, if the operator and owner of the machine have agreed to increase the annual limit of the machine, from $3,000 per year to $4,500 per year, then a code can be released to the operator for communication to the machine ( or transmitted to the machine directly if the connection is available) which causes the computer control system of the apparatus to modify the restriction of disabling accordingly.

Additionally, an operator could agree with a managing entity to have the ability to apply usage credits to a group of separate equipment. So in this way, the operator can apply credits to any one of several pieces of his equipment.

If an additional entity has contracted with the operator to sell a specific type of product or brand of goods, the machine and ID system can communicate to the central computer system in order to monitor compliance to the parameter. If the periodic continuation code is not input to the machine, the machine may be pre-programmed to disable part or all of the apparatus or to modify or limit in some way the features or capabilities of the machine. The authorization code required may be released by an authorized entity when the entity is satisfied that the agreement between the parties is being met.

In some cases, the contracts between numerous entities may be controlled together or separately relating to the same piece of equipment. So, for example, if the owner of a vending machine is the operator of the machine he may be interested in renting out space in the machine, much like a mall owner might rent out space in a building. Numerous entities may have an interest in the same piece of equipment. The financial investor or leasing company might simply wish to know that the machine is creating a threshold of revenue. Various sellers of goods or suppliers of products may wish to guarantee the space for storing and selling their products out of the machine. Using a central computer, which may be operated by a separate management entity, the owner/operator of the machine may have contracts with the various interested parties whereby the management entity collects, verifies, authenticates and redistributes the data relating to the vending machine. Furthermore, the management company may be authorized to debit, credit or bill various parties automatically as the data from the machine is received and analyzed. A given agreement can even design so that, depending on the performance of the sales of a given product, the operator or the supplier of goods could be required to pay the other a payment. If the product sells well, for example, the operator may be entitled to a bonus payment or rebate payment from the goods producer. However, if the sales of the goods are poor, the operator may be require to refund a portion or all of the rental payment which the goods producer paid for renting the machine space. This information and transaction of funds can all be processed by one or more central computer systems which are communicating directly or indirectly with all of the relevant entities. In another agreement relating to the same machine, the operator may be required to make payments to buy the machine from the machine producer. The machine producer may contract with the operator, and the management company for receiving at least part of the payment or compensation for the machine as coming from the payments being made by yet another entity such as the goods producer. So, for example, if the goods producer is debited for a rebate owed to the operator, the operator could assign part or all of the payment to be transferred directly or indirectly to the account of another entity, such as the machine manufacturer. In this way, accounts can be settled or bartered or exchanged between multiple parties without necessarily having the monies transfer to initial recipient. The central computer then acts as an exchange system which can facilitate numerous business dealings, both monetary as well as non-monetary exchanges, communications and services.

Numerous scenarios are contemplated by the present invention which utilize the described invention and many permutations of the invention are possible.

In an embodiment where the bins or storage compartments are turned in a horizontal manner so that the longitudinal axis is in the horizontal plane, the support tabs are not as needed as support structures for keeping the articles from crushing one another due to gravity. However, the support tabs still serve a function in both transporting articles stored therein as well as supporting articles from falling over or becoming disorganized within the bin or horizontal shelf storage area. The tabs, in this embodiment may be placed near the top of the articles within the storage compartment or shelf, so as to support the top of the article in particular, Thereby ensuring that the articles won't move or fall.

The following invention is especially useful for equipment which is leased, rented, loaned, or licensed from one entity to another entity (such as a washing machine or an industrial or household appliance), or where one entity has an interest in controlling the usage of equipment which a second entity is in the physical control possession, custody etc. of the equipment with at least one other interested entity where the system includes:

i. a first computer having recorded information relating to the usage of a piece of equipment and,

ii. the recorded information is communicated to at least one other computer system,

iii. the at least one other computer system compares the information received to a database and determines whether the equipment is being used in a prescribed manner,

iv. if the equipment is being used in a prescribed manner, then the one other computer can release a continuation code which can be communicated back to the first computer which can prevent the first computer from being disabled.

b. A piece of equipment controlled by an equipment computer control system linked to the equipment, and whereby the computer control system is operable to disable the equipment upon the occurrence of a predetermined parameter being met.

c. Where the equipment computer control system can record data relating to at least one attribute (such as time, usage, unauthorized uses) or parameter in the equipment, and is able to release at least some of the data to another computer control system through some communication link.

d. Where the equipment computer control system can store a program memory which enables the equipment to perform a complete range of functions.

e. Where the computer control system can store in its memory prescribed parameters which determine specific restrictions or limitations which limit the equipment from being able to perform the complete range not able to operate.

f. Where at least some of the data recorded by the equipment control system can be communicated from the equipment (using a data link, and preferably using an encryption technique to secure the data) to an external computer system.

g. Where The external computer system can receive the data from the equipment ({dependent}=and if the data is encrypted, it can be decrypted and thereby authenticated as genuine and unadulterated data), and

h. Where the external computer system is able to store information relating to the prescribed parameters which relate to its authorized usage.

i. The remote computer system compares the usage and the specific ways in which the equipment was used to determine what if any action or decision should be taken

2) FURTHER AS ABOVE including a piece of machinery or equipment which can also have security circuits throughout the system so that if the computer is altered or changed, the other components in the equipment would refuse to work.

3) In some cases, the equipment has multiple capabilities, so that it can be used with more or less features or limitations, some or all of which can be disabled or modified based on information received, monitored or learned by the equipment control system.

4) As described above where the amount of usage must first be reported back to the remote computer before a continuation code can be released (such as with a leased car etc.)

5) This data can also be used to build a data base to allow an equipment manufacturer or finance company understand how the equipment is being used This can be useful information when designing finance plans, marketing, advertising plans and equipment.

6) As above were the remote computer system takes into consideration the information communicated-from-the-equipment computer control and-the information within the database relating to the creditworthiness of at least one entity.

7) Computer systems (first and remote) and their control aspects and their link to other apparatus in the machine.

In one embodiment of a multiple robot configuration may be contained within a warehousing structure. The system can utilize a common computer system to control all processes including conveyance, dispensing and monitoring whereby at least one conveyor system for moving a containment structure, such as a bag, basket, box or other type of container from one location to another, the system further having at least two robots are positioned so as to be operative to remove articles from storage bins (eg. Typically articles of different types with different storage requirements) within the reach of the respective robots. The conveyor system which may be of many varied methods generally known can convey the container in order to allow the robots to place articles within their reach into the common bag or box prior to dispensing or conveying the container or box to a customer retrieval location. This customer retrieval location or locations can be remote to the housing structure that contains the article storage facilities and or the article conveyor systems. Additionally the other described aspects of the invention, such as article ID systems, control techniques and mechanical apparatus described herein may be applied to this embodiment. Other aspects that can be utilized advantageously here may be connection to a computer network such as the internet, LAN, WAN, Wireless etc. wherein a customer or user may monitor or order from the system. In one scenario, the user can order articles to be dispensed over the computer network and have them ready and waiting in a customer holding area so that the customer can retrieve the container or articles at a later time. A user can also use a touch screen in proximity to the automated dispensing system or retrieval area and or the remote computer system or network to check the inventory or availability of a specific item or items. In a further embodiment, This system can also be utilized as a mini warehouse system. In this scenario, the storage areas may contain articles or packages which are placed there specifically for access and retrieval by a certain person or entity. Using a passcode or access card or similar device or using a payment method, the user can retrieve packages such as parcels, letters, or other shipped goods from the storage area. This provides for a very convenient system since traditional deliveries to a person or entities home or place of business often requiring a physical signature and for a both parties to be present to receive and have the article delivered. Instead, the delivering party and the receiving party can use the article storage and dispensing apparatus as an exchange device allowing for the two parties to carry out the transfer of goods without having the requirement of being at the same place at the same time. Additionally, the use of a pass code or a swipe card, which may be connected to a gasoline pump, or any one of a multitude of devices, including biometric devices such as facial or fingerprint recognition, could be used as a verifiable electronic signature to ensure accountability. The elements described herein can be used in various other useful combinations which are considered part of the invention.

This dispensing apparatus can be used in locations such as Gas Station islands, parking lots or convenience stores etc. whereby products are delivered to customers from the dispensing apparatus, for example, using a pneumatic tube, or a conveyor system bringing articles from a remote storage area of the vending apparatus to a location on the the apparatus whereby the customer interface, such as a touch screen device and remote retrieval area can be accessed by the customer for remote delivery of articles conveyed and dispensed from the vending apparatus. The described invention can be used in an automated supermarket and such things as automated storerooms or stockrooms in office buildings and commercial locations.

Furthermore, where the central computer system has software code that enables it to manage, determine, and execute the financial matters between the entities. Such matters may include debiting or crediting accounts of various of the involved entities or creating a bill or invoice for one entity to present to another entity. This financial information is determined from analysis of the information which may be communicated to the central computer system from at least one other source. Other sources may include, the control system of the vending apparatus or, for example, the computer network or system of an involved or interested entity.

In one scenario, an operator desires a vending apparatus so he can place it at a specific location. In some instances, an operator doesn't know how much activity the machine will get and he therefore may have to decide whether he can justify placing the machine at the location. One of the significant factors needed to make the decision for whether or not to place the vending machine in a location (or for that matter, whether or not to buy or lease or rent the machine at all) is obviously the cost of the machine. While various traditional financing methods may be useful to stretch out the cost of the machine over time, none are designed to determine the payment or payments to be paid for the machine, by the operator or other interested entity, based on the performance parameters of the machine in a specific circumstance. For example, a parameter may be the amount of money inserted into the machine over a specific time period. Alternatively (or additionally) another parameter may be how many units were sold over a specific time or further without any measured relationship to a time element. So, for example, the seller or owner of the machine may wish to lease or rent or sell the equipment to an operator or user and is willing to have the cost of the equipment to the operator or user be determined at least partially (or fully, if agreed) based on a parameter related to the machine, such as the amount of sales generated from the machine. Following this scenario, a machine manufacturer or a leasing company may be willing to lease or rent the equipment to the operator (operator could be a buyer in this case or a renter etc.) for a payment or price that is less than the traditional market price equivalent. The monthly payment may, for example, have a very nominal (or none at all) profit margin for the machine manufacturer or leasing company to benefit from initially. The regular payment (if there is agreed to be one at all) is fixed in this example and the user or operator must pay additional payments which are determined based on his usage of the equipment. Furthermore, the equipment may have a minimal or limited ability to operate, either in terms of features which are limited or in terms of usage which may be limited or restricted. So, for example, a given piece of equipment may be pre-programmed to disable if more than $3,000 of vending or revenue has occurred within a time frame of one year. The control system may be further programmed to reset a specific counter, which counts the money received by the machine, whenever the time interval of one year has passed. Therefore, if the operator finds himself having vended $2,954 dollars within a twelve month interval, he doesn't have to worry about the machine disabling, since on the first day of the new cycle the meter will turn back to $0 dollars vended and will again allow another $3,000 to be vended over the subsequent twelve months. However, if the operator has vended $3,000 worth of goods and there are still, for example, 3 months left in the year the machine will be disabled. In order to avoid the disabling of the machine, the operator would, for example, contact the management entity who controls the enabling codes for the machine and the operator would pay (or agree to be billed for ) an increased ability to utilize the equipment. The operator may choose to pay for the ability to vend, for example, $1,500 of additional goods during the remaining 3 months of the year. Of course the system can be set to allow any remaining additionally ability to use purchased usage credits, to continue into the following time interval or period of the following year so in this way, an operator doesn't need to be accurate in predicting his additional usage requirements on a given machine. The managing entity, typically a manager which represents the owner or leasing company or manufacturer, will determine (possibly automatically through use of the central computer system)whether or not to release an authorization code such as a continuation code (or an enable, re-enable etc. code as the case may be, a re-enable code is needed after the equipment has already been shut down) to the operator or entity requesting the code. Once the code is received and accepted by the computer control system of the vending apparatus, the vending machine will continue on as per the specific instructions of the latest received authorization code. The authorization code might, for example, also change the ongoing limitations of the machine if so determined. For example, if the operator and owner of the machine have agreed to increase the annual limit of the machine, from $3,000 per year to $4,500 per year, then a code can be released to the operator for communication to the machine (or transmitted to the machine directly if the connection is available) which causes the computer control system of the apparatus to modify the restriction of disabling accordingly.

Additionally, an operator could agree with a managing entity to have the ability to apply usage credits to a group of separate equipment. So in this way, the operator can apply credits to any one of several pieces of his equipment.

If an additional entity has contracted with the operator to sell a specific type of product or brand of goods, the machine and ID system can communicate to the central computer system in order to monitor compliance to the parameter. If the periodic continuation code is not input to the machine, the machine may be pre-programmed to disable part or all of the apparatus or to modify or limit in some way the features or capabilities of the machine. The authorization code required may be released by an authorized entity when the entity is satisfied that the agreement between the parties is being met.

In some cases, the contracts between numerous entities may be controlled together or separately relating to the same piece of equipment. So, for example, if the owner of a vending machine is the operator of the machine he may be interested in renting out space in the machine, much like a mall owner might rent out space in a building. Numerous entities may have an interest in the same piece of equipment. The financial investor or leasing company might simply wish to know that the machine is creating a threshold of revenue. Various sellers of goods or suppliers of products may wish to guarantee the space for storing and selling their products out of the machine. Using a central computer, which may be operated by a separate management entity, the owner/operator of the machine may have contracts with the various interested parties whereby the management entity collects, verifies, authenticates and redistributes the data relating to the vending machine Furthermore, the management company may be authorized to debit, credit or bill various parties automatically as the data from the machine is received and analyzed. A given agreement can even design so that, depending on the performance of the sales of a given product, the operator or the supplier of goods could be required to pay the other a payment. If the product sells well, for example, the operator may be entitled to a bonus payment or rebate payment from the goods producer. However, if the sales of the goods are poor, the operator may be require to refund a portion or all of the rental payment which the goods producer paid for renting the machine space. This information and transaction of finds can all be processed by one or more central computer systems which are communicating directly or indirectly with all of the relevant entities. In another agreement relating to the same machine, the operator may be required to make payments to buy the machine from the machine producer. The machine producer may contract with the operator, and the management company for receiving at least part of the payment or compensation for the machine as coming from the payments being made by yet another entity such as the goods producer. So, for example, if the goods producer is debited for a rebate owed to the operator, the operator could assign part or all of the payment to be transferred directly or indirectly to the account of another entity, such as the machine manufacturer. In this way, accounts can be settled or bartered or exchanged between multiple parties without necessarily having the monies transfer to initial recipient. The central computer then acts as an exchange system which can facilitate numerous business dealings, both monetary as well as non-monetary exchanges, communications and services.

Numerous scenarios are contemplated by the present invention which utilize the described invention and many permutations of the invention are possible.

In an embodiment where the bins or storage compartments are turned in a horizontal manner so that the longitudinal axis is in the horizontal plane, the support tabs are not as needed as support structures for keeping the articles from crushing one another due to gravity However, the support tabs still serve a function in both transporting articles stored therein as well as supporting articles from falling over or becoming disorganized within the bin or horizontal shelf storage area. The tabs, in this embodiment may be placed near the top of the articles within the storage compartment or shelf so as to support the top of the article in particular, Thereby ensuring that the articles won't move or fall.

The following invention is especially useful for equipment which is leased, rented, loaned, or licensed from one entity to another entity (such as a washing machine or an industrial or household appliance), or where one entity has an interest in controlling the usage of equipment which a second entity is in the physical control possession, custody etc. of the equipment with at least one other interested entity where the system includes:

i. a first computer having recorded information relating to the usage of a piece of equipment and

ii. the recorded information is communicated to at least one other computer system

iii. the at least one other computer system compares the information received to a database and determines whether the equipment is being used in a prescribed manner

iv. if the equipment is being used in a prescribed manner, then the one other computer can release a continuation code which can be communicated back to the first computer which can prevent the first computer from being disabled.

b. A piece of equipment controlled by an equipment computer control system linked to the equipment, and whereby the computer control system is operable to disable the equipment upon the occurrence of a predetermined parameter being met.

c. Where the equipment computer control system can record data relating to at least one attribute (such as time, usage, unauthorized uses) or parameter in the equipment, and is able to release at least some of the data to another computer control system through some communication link.

d. Where the equipment computer control system can store a program memory which enables the equipment to perform a complete range of functions.

e. Where the computer control system can store in its memory prescribed parameters which determine specific restrictions or limitations which limit the equipment from being able to perform the complete range not able to operate.

f. Where at least some of the data recorded by the equipment control system can be communicated from the equipment (using a data link, and preferably using an encryption technique to secure the data) to an external computer system.

g. Where The external computer system can receive the data from the equipment ({dependent}=and if the data is encrypted, it can be decrypted and thereby authenticated as genuine and unadulterated data), and

h. Where the external computer system is able to store information relating to the prescribed parameters which relate to its authorized usage.

i. The remote computer system compares the usage and the specific ways in which the equipment was used to determine what if any action or decision should be taken

2) FURTHER AS ABOVE including a piece of machinery or equipment which can also have security circuits throughout the system so that if the computer is altered or changed, the other components in the equipment would refuse to work.

3) In some cases, the equipment has multiple capabilities, so that it can be used with more or less features or limitations, some or all of which can be disabled or modified based on information received, monitored or learned by the equipment control system.

4) As described above where the amount of usage must first be reported back to the remote computer before a continuation code can be released (such as with a leased car etc.)

5) This data can also be used to build a data base to allow an equipment manufacturer or finance company understand how the equipment is being used. This can be useful information when designing finance plans, marketing, advertising plans and equipment.

6) As above where the remote computer system takes into consideration the information communicated from the equipment computer control and the information within the database relating to the creditworthiness of at least one entity.

7) Computer systems first and remote) ad their control aspects and their link to other apparatus in the machine.

1. A first computer system having at least one computer processor and at least some ability to record and store data,
a second computer system having at least one computer processor and at least some ability to record and store data, and
the first computer system having a predetermined set of functions (and or combinations of functions, eg. x, y and z motors moving in a specific pattern to get a specific product, or to scan a bar code) which can be performed.

2. The apparatus of claim 1, wherein the first computer controls at least one motor.

3. The apparatus of claim 1, wherein the second computer system is preprogrammed to disable at least some of the predetermined set of functions of the first computer.

4. The apparatus of claim 3, wherein an enable codei s stored/released from the second computer system which can be communicated to the first computer and will at least partially prevent said first computer system from said disabling.

5. The apparatus of claim 1, wherein the first computer system is enabled to monitor and record data relating to activity of specific functions which have been performed by the first computer, (such as operating a piece of equipment in a specific manner).

6. The apparatus of claim 5, wherein the first computer is enabled to communicate the said activity data to at least one other computer.

7. The apparatus of claim 5, wherein the second computer system is enabled to receive the activity data from the first computer.

8. The apparatus of claim 1, wherein the second computer system has stored data which defines at least one prescribed limit or where the limit is created within the second computer system (e.g. based on credit history etc.), the limit relating to the activity of functions performed by the first computer.

9. The apparatus of claim 8, wherein the second computer system is enabled to compare the activity data of the functions performed to the at least one prescribed limit in order to determine if the activity of at least one of the functions performed by the first computer was within the prescribed limit.

10. The apparatus of claim 8, wherein the second computer system is operable to release an enable code for the first computer system if the second computer system determines that the functions performed by the first computer were within the prescribed limit.

11. The apparatus of claim 10, wherein the second computer restricts the release of an enable code for the first computer if it determines that the functions performed by the first computer were not within the prescribed limit.

12. The apparatus of claim 1, wherein first computer is connected (or linked) to at least one other device.

13. The apparatus of claim 12, wherein the first computer stores a unique security identification code (which identifies the computer as authentic).

14. The apparatus of claim 13, wherein the at least one other device contains at least one security circuit which is able to detect the connection with the first computer and furthermore is able to communicate with the first computer in order to at least determine whether the first computer is authentic.

15. The apparatus of claim 14, wherein the two computers are truly separate/ and where the ability to initiate the process comes from the data first being received from the first computer.
